(19) United States
(12) Patent Application Publication
(10) Pub. No.: US 2009/0251430 A1
(43) Pub. Date: Oct. 8, 2009

(54) Circuit complexity reduction of a capacitive touch system

(76) Inventors: Tse-Lun Hung, Taipei City (TW); Jung-Shou Huang, Da-an Shiang (TW); Chang-Hsin Chen, Shalu Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/385,096

(22) Filed: Mar. 31, 2009

(30) Foreign Application Priority Data
Apr. 2, 2008 (TW) 097112059

(51) Int. Cl. G06F 3/041

(52) U.S. Cl. 345/173

(57) ABSTRACT

A capacitive touch system uses at least two first integrated circuits to simultaneously scan a touch panel, each of the first integrated circuits only for scanning a portion of the touch panel. Therefore, the capacitive touch system can maintain a good frame rate, even the touch panel is a large scale touch panel. Each of the first integrated circuits transmits its sensed data to a second integrated circuit where a calculation with the received sensed data is executed. The second integrated circuit has at least a common pin connected to each of the first integrated circuits, and therefore the number of pins of the second integrated circuit is reduced.

### FIELD OF THE INVENTION

The present invention is related generally to a capacitive touch system and, more particularly, to a structure for circuit complexity reduction of a capacitive touch system.

### BACKGROUND OF THE INVENTION

In conventional applications, all the large scale capacitive touch panels use a surface capacitance sensing technique to scan thereto for determining a touch information, which uses a set of sensing currents, each directed to an endpoint of the large scale touch panel to produce sensed values, and therefore, even multiple fingers simultaneously touch the large scale touch panel, this sensing technique still retrieves only one set of sensed currents in response to this multi-finger touch. For this reason, the surface capacitance sensing technique can identify only one set of absolute coordinates. In a two dimensional matrix for instance, only one set of parameters (X,Y) will be determined, and thereby it can't implement a multi-finger touch detection.

An all points addressable (APA) projected capacitance sensing technique is capable of implementing a multi-finger touch detection, but not applicable to large scale touch panels because, to implement this sensing technique, it is necessary to charge and discharge each point sensor on the large scale touch panel. Taking a matrix-type touch panel for example, when the X and Y traces increase, the pixel number of an APA projected capacitance touch panel dramatically increases and thereby significantly degrades the frame rate of the touch panel due to the very long time period for scanning the large scale touch panel in a frame.

An axis intersect (AI) projected capacitance sensing technique is also capable of implementing a multi-finger touch-detection, but not applicable to large scale touch panels, too. FIG. 1 is a schematic diagram of a conventional AI projected capacitance sensing technique applied to a small scale touch panel 10, in which an AI projected capacitance touch IC 12 is used to scan the small scale touch panel 10. Assuming that the AI projected capacitance touch IC 12 can support up to 22 traces, a good frame rate can be attained for a small scale touch panel 10 having ten X traces TRX1-TRX10 and ten Y traces TRY1-TRY10. However, if a this type touch IC 12 is applied to a large scale touch panel 14 having forty X traces TRX1-TRX40 and forty Y traces TRY1-TRY40, as shown in FIG. 2, the total number of traces that the touch IC 12 needs to scan dramatically increases. Unfortunately, the frame rate of the overall touch panel application is dependent to a very large extent on the time it takes the touch IC 12 to charge and discharge capacitors each time. In other words, the frame rate is determined mainly by the time in a frame that the touch IC 12 charges and discharges the capacitors. Hence, if an AI projected capacitance touch IC capable of scanning a greater number of traces is applied to a large scale touch panel 14, a major drawback would be a significantly decreased frame rate in the overall application, which leads to compromised performance at the application end.

### SUMMARY OF THE INVENTION

An object of the present invention is to provide a capacitive touch system applicable to large scale touch panels with a multi-finger touch detection, a good frame rate, and low circuit complexity.

According to the present invention, a capacitive touch system uses at least two first integrated circuits to simultaneously scan a touch panel, each of the first integrated circuits responsible for scanning only a respective portion of the touch panel. The first integrated circuits transmit their sensed data to a second integrated circuit where a calculation with the received sensed data is executed. Alternatively, each or any of the first integrated circuits may share a calculation with its sensed data or all the sensed data. In addition, the second integrated circuit may also participate in scanning for a respective portion of the touch panel. Each of the first integrated circuits has at least a pin to transmit its sensed data, and the second integrated circuit has at least a common pin connected to the at least a pin of each of the first integrated circuits to receive the sensed data therefrom. This structure reduces the number of required pins of the second integrated circuit and thereby lowers the overall circuit complexity.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a schematic diagram of a conventional AI projected capacitance sensing technique applied to a small scale touch panel;

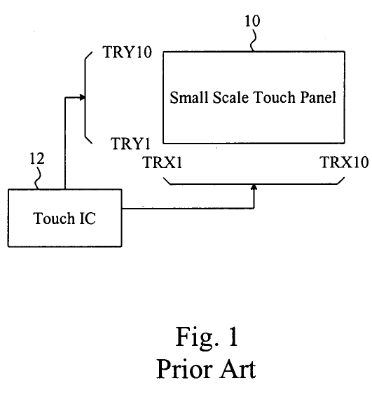

FIG. 2 is a schematic diagram of a conventional AI projected capacitance sensing technique applied to a large scale touch panel;

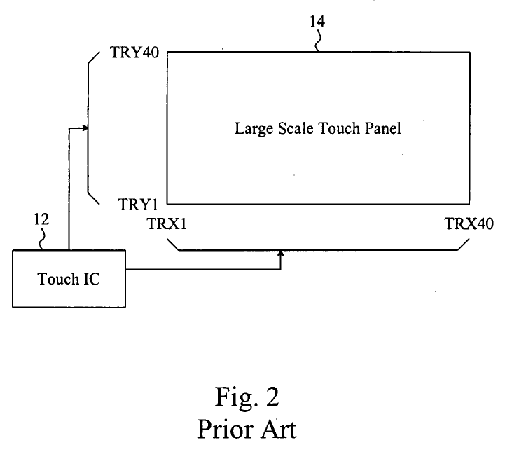

FIG. 3 is a schematic diagram of a capacitive touch system using at least two AI projected capacitance touch ICs to scan a touch panel;

FIG. 4 is a schematic diagram of a first embodiment according to the present invention;

FIG. 5 is a schematic diagram of a second embodiment according to the present invention;

FIG. 6 is a schematic diagram of a third embodiment according to the present invention; and

FIG. 7 is a schematic diagram of a fourth embodiment according to the present invention.

### DETAILED DESCRIPTION OF THE INVENTION

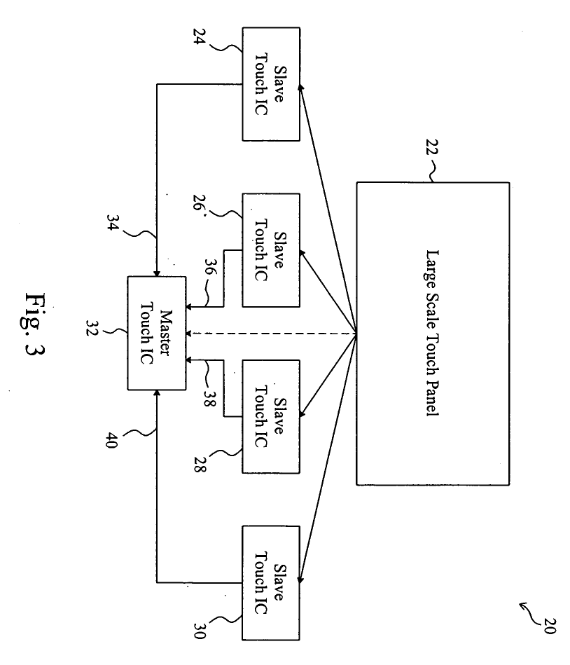

According to the present invention, as shown in FIG. 3, a capacitive touch system 20 uses □□□□ AI projected capacitance touch ICs 24, 26, 28 and 30 to simultaneously scan a large scale touch panel 22 to increase the frame rate of the capacitive touch system 20. Assuming that the large scale touch panel 22 has eighty traces, each of the touch ICs 24-30 is responsible for scanning respective twenty traces. Each of the touch ICs 24-30 is a slave touch IC, and transmits its sensed data to a master touch IC 32 where the received sensed data are used for final and overall calculation, and subsequent actions may be determined for intended applications. If needed, the master touch IC 32 may also take part in scanning, as indicated by the dashed line in FIG. 3. Alternatively, the slave touch ICs 24-30 may share some calculation to reduce the loading of the master touch IC 32. If to receive the sensed data from all the slave touch ICs 24-30 individually, the master touch IC 32 will need four pins 34, 36, 38 and 40, each for one of the slave touch ICs 24-30. For each additional slave touch IC, the master touch IC 32 will need more one pin to receive the sensed data therefrom. Therefore, as the number of the slave touch ICs increases, the number of pins of the master touch IC 32 will increase accordingly. To reduce the circuit complexity, especially for great number of slave touch ICs applications, structures are provided.

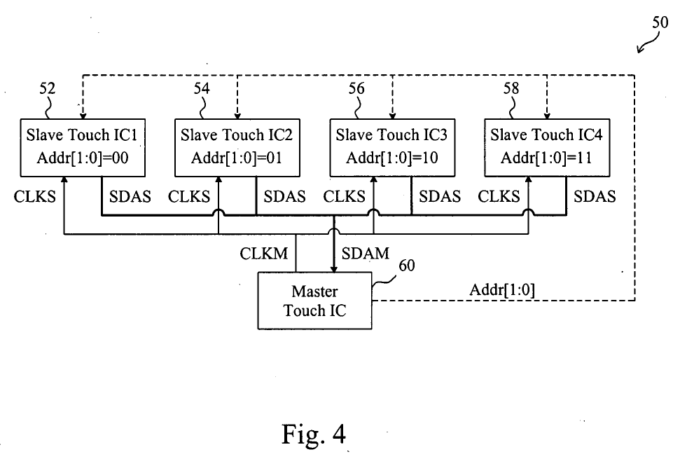

FIG. 4 is a schematic diagram of a first embodiment according to the present invention, in which a capacitive touch system 50 includes four AI projected capacitance touch ICs 52, 54, 56 and 58 as the slave touch ICs to scan a touch panel (not shown) and for their sensed data, transmit with serial data to a master touch IC 60 in a serial transmission mode, as does a serial port. Each of the slave touch ICs 52-58 has two pins CLKS and SDAS, the pins SDAS of all the slave touch ICs 52-58 are connected together to a common pin SDAM of the master touch IC 60, and the pins CLKS of all the slave touch ICs 52-58 are connected together to a common pin CLKM of the master touch IC 60: This structure may reduce the number of pins of the master touch IC 60. The master touch IC 60 sends out a clock to the pin CLKS of each of the slave touch ICs 52-58 via the common pin CLKM, and receives the sensed data from each of the slave touch ICs 52-58 via the common pin SDAM. The master touch IC 60 further has a common pin Addr[1:0] to send out an address signal with the address of either one of the slave touch ICs 52-58. In order to prevent collision between the sensed data of the slave touch ICs 52-58, the pin Addr[1:0] sends out the address signal to each of the slave touch ICs 52-58 to specify one of them each time when requesting the sensed data therefrom. For example, if the address signal Addr[1:0] is “00”, the slave touch IC 52 is prompted to transmit its sensed data to the master touch IC 60 in a serial transmission mode while the others 54-58, upon detecting the address signal as not directed to themselves, set their corresponding pins SDAS in a high impedance state or a floating state, so that the sensed data received by the master touch IC 60 from the slave touch IC 52 will not be not affected by the others 54-58. The master touch IC 60 requests and receives the sensed data from the other slave touch ICs 54-58 in a similar way.

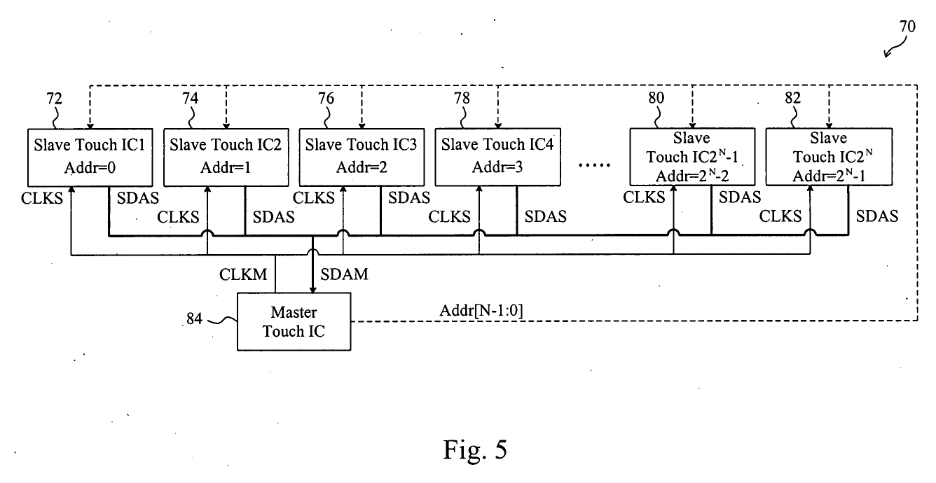

FIG. 5 is a schematic diagram of a second embodiment according to the present invention, in which a capacitive touch system 70 has much more slave touch ICs 72-82, also configured with a serial transmission scheme, for example, as that shown in FIG. 4. The number of the total slave touch ICs 72-82 is 2^{N}, where N is a natural number. Each of the slave touch ICs 72-82 is an AI projected capacitance touch IC, and is responsible for scanning a respective portion of a touch panel (not shown). All the slave touch ICs 72-82 transmit their sensed data to a master touch IC 84 in a serial transmission mode, as does a serial port. Each of the slave touch ICs 72-82 has two pins CLKS and SDAS, all the pins SDAS are connected together to a common pin SDAM of the master touch IC 84, and all the pins CLKS are connected together to a common pin CLKM of the master touch IC 84. The master touch IC 84 sends out a clock to the pin CLKS of each of the slave touch ICs 72-82 via the common pin CLKM, and receives sensed data from each of the slave touch ICs 72-82 via the common pin SDAM. For request of the sensed data, as that shown in FIG. 4, the master touch IC 84 has a pin Addr[N−1:0] to send out an N-bit address signal to select from the slave touch ICs 72-82. Even so many slave touch ICs in this embodiment, the master touch IC 84 still requires only three pins to request and receive all the sensed data from the slave touch ICs. This structure reduces much more pins that are needed for the master touch IC 84.

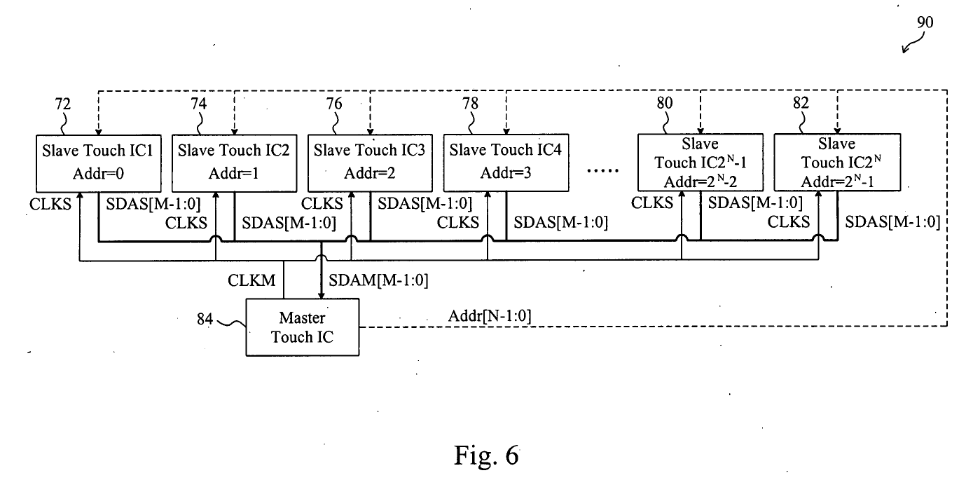

FIG. 6 is a schematic diagram of a third embodiment according to the present invention, in which each of slave touch ICs 72-82 transmits its sensed data to a master touch IC 84 in a parallel transmission mode to increase the data transmission speed. The number of the slave touch ICs 72-82 in this capacitive touch system 90 is also 2^{N}, where N is a natural number. For each of the slave touch ICs 72-82, the number of pins to transmit its sensed data is M, where M is a natural number, and the sensed data will be transmitted with a data width of M. To reduce the number of pins of the master touch IC 84, the pins SDAS[M−1:0] of all the slave touch ICs 72-82 are connected together to common pins SDAM[M−1:0] of the master touch IC 84, the pins CLKS of all the slave touch ICs 72-82 are connected together to a common pin CLKM of the master touch IC 84 to receive a clock therefrom, and the master touch IC 84 also sends out an address signal Addr[N−1:0] to select from the slave touch ICs 72-82 for request of their sensed data. In this embodiment, each of the 2^{N} slave touch ICs 72-82 transmits its sensed data in a M-bits manner to the master touch IC 84 in a parallel transmission mode.

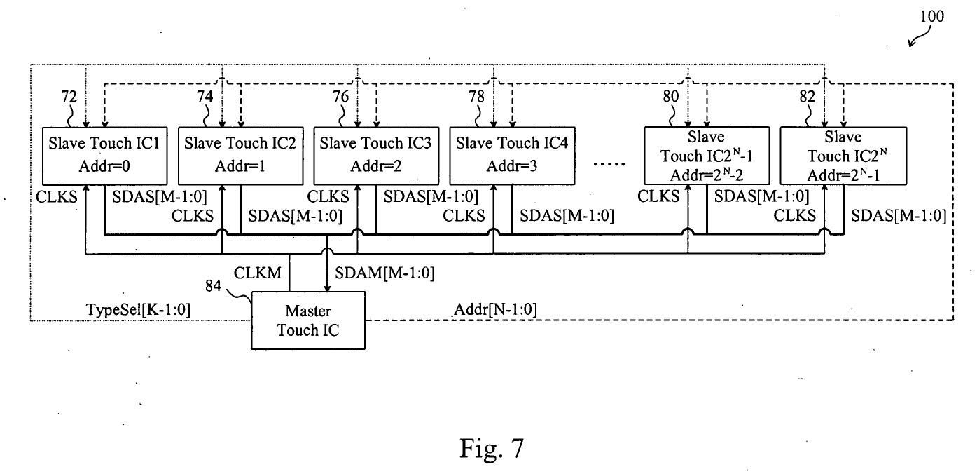

FIG. 7 is a schematic diagram of a fourth embodiment according to the present invention, in which a capacitive touch system 100 also includes 2^{N} slave touch ICs 72-82 and a master touch IC 84. However, the slave touch ICs 72-82 in this embodiment include various packet modes for data transmission, and for which the master touch IC 84 has an additional port Typesel[K−1:0] of K pins, where K is a natural number, for selecting from 2^{K} data formats, for example, one for transmitting only non-zero sensed values, to achieve a high overall frame rate for various applications. In this embodiment, each of the slave touch ICs 72-82 also transmits its sensed data to the master touch IC 84 in a parallel transmission mode. In other embodiments, it may transmit the sensed data in a serial transmission mode.

In FIGS. 5, 6 and 7, the address signal for selecting from the slave touch ICs may also be implemented by a single pin, in association with a pulse string in the clock on the common pin CLKM transmitted in a serial manner to each of the slave touch ICs to specify one thereof. Each of the slave touch ICs has a respective identification code, and knows that it is requested by the master touch IC as the received address signal matches with its identification code.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims

What is claimed is:

1. A capacitive touch system, comprising;
a touch panel;
at least two first integrated circuits connected to the touch panel, each of the first integrated circuits scanning a respective portion of the touch panel and having at least a first pin to transmit its sensed data retrieved by itself; and
a second integrated circuit having at least a second pin connected to the at least a first pin of each of the first integrated circuits to receive the sensed data therefrom, and calculating with the received sensed data.

2. The capacitive touch system of claim 1, wherein each of the first integrated circuits comprises an axis intersect projected capacitance touch integrated circuit.

3. The capacitive touch system of claim 1, wherein each of the first integrated circuits transmits its sensed data to the second integrated circuit in a serial transmission mode.

4. The capacitive touch system of claim 1, wherein each of the first integrated circuits transmits its sensed data to the second integrated circuit in a parallel transmission mode.

5. The capacitive touch system of claim 1, wherein the second integrated circuit sends out an address signal to select one from the first integrated circuits to transmit the sensed data thereof.

6. The capacitive touch system of claim 5, wherein the second integrated circuit has at least a third pin connected to each of the first integrated circuits to send the address signal thereto.

7. The capacitive touch system of claim 1, wherein the second integrated circuit sends out a selection signal to determine a data format for the sensed data to be sent from any one of the first integrated circuits.

8. The capacitive touch system of claim 1, wherein the second integrated circuit has a third pin connected to each of the first integrated circuits to send a clock thereto.

9. The capacitive touch system of claim 1, wherein the second integrated circuit is responsible for scanning a respective portion of the touch panel.
